(19) United States
(12) Patent Application Publication
(10) Pub. No.: US 2002/0158106 A1
(43) Pub. Date: Oct. 31, 2002

(54) Cartridge type soldering iron with a releasable and replaceable handle

(75) Inventor: Bungo Yokoo, Osaka (JP)

Correspondence Address: Squire, Sanders & Dempsey L.L.P., 14th Fl., 801 S. Figueroa Street, Los Angeles, CA, 90017-5554, US

(73) Assignee: Hakko Corporation

(21) Appl. No.: 09/842,992

(22) Filed: Apr. 26, 2001

(51) Int. Cl. B23K 3/02

(52) U.S. Cl. 228/55; 228/51

(57) ABSTRACT

The present invention allows a user to select a handle that is ergonomically friendly to a user's hand and replace it with the replaceable handle that is design to fit over a soldering iron rod. There are a number of advantages to the present invention. One of the advantages is that a user can choose its own handle with the desired, shape, size, color, and material. Another advantage is that since each user has its own handle, hygiene problems may be minimized. Still another advantage is the cost savings because as the replaceable handle wares out, only the handle needs to be replaced rather than the whole soldering iron.

### BACKGROUND OF THE INVENTION

1. Field of the Invention

This invention relates generally to a soldering iron and, more particularly, to a soldering iron having a releasable and replaceable cartridge and associated handle that may be replaced with a customized handle for a particular user.

2. Description of the Related Art

Cartridge type soldering irons have been in use for a number of years. One example of a cartridge type soldering iron is disclosed in U.S. Pat. No. 4,839,501. As disclosed therein, there is a replaceable cartridge and associated rigid handle. One of the problems with a soldering iron with a replaceable cartridge as shown in the 4,839,501 patent is that it is not comfortable for every user. That is, if a user does not like the size or shape of the handle of a soldering iron, the user has to either find another iron that is more comfortable or continue to use the uncomfortable soldering iron. Moreover, a soldering iron may be handled by a number of users, which can cause hygiene problems. This is especially true because people's hands pass most germs.

Therefore, there is a need for a cartridge type soldering iron having a handle that can be fitted to a particular user and, at the same time, minimize any hygiene problems being caused by a number of users handling the same soldering iron.

### BRIEF SUMMARY OF THE INVENTION

The present invention solves the aforementioned problems with a cartridge type soldering iron by providing a handle that is releasable from the soldering iron cartridge and replaceable with a handle that is more comfortable to the user. This allows a user to select a handle that is ergonomically friendly to his hand and replace it with the replaceable handle that is design to fit the soldering iron cartridge. There are a number of advantages to the present invention. One of the advantages is that a user can choose its own handle with the desired, shape, size, color, and material. Another advantage is that since each user has its own handle, hygiene problems may be minimized. Still another advantage is the cost savings because as the replaceable handle wares out, only the handle needs to be replaced rather than the whole soldering iron.

The above described and many other features and attendant advantages of the present invention will become apparent from a consideration of the following detailed description when considered in conjunction with the accompanying drawings.

### BRIEF DESCRIPTION OF THE DRAWINGS

A detailed description of exemplary embodiments according to the invention will be made with reference to the accompanying drawings.

FIG. 1 is an exemplary view of an assembled soldering iron in accordance with one embodiment of the present invention;

FIG. 2 is an exemplary view of a disassembled soldering iron of FIG. 1;

FIG. 3 is an exemplary view of a disassembled soldering iron in accordance with an alternative embodiment of the present invention;

FIG. 4 is an alternative embodiment of a connector; and

FIG. 5 is yet another alternative embodiment of a connector.

### DETAILED DESCRIPTION OF THE INVENTION

This description is not to be taken in a limiting sense, but is made merely for the purpose of illustrating the general principles of the invention. The section titles and overall organization of the present detailed description are for the purpose of convenience only and are not intended to limit the present invention.

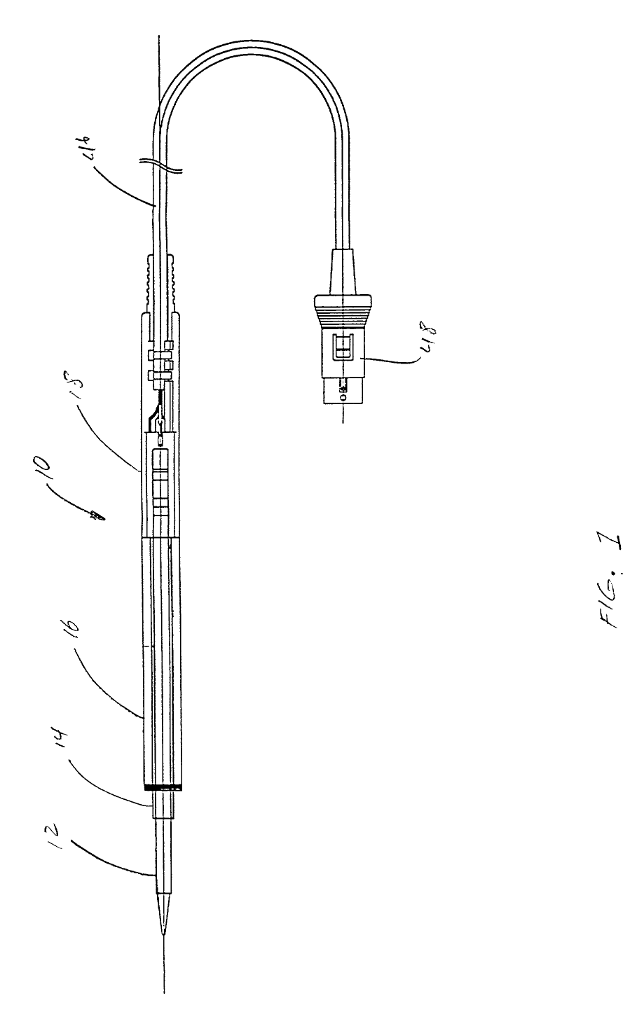

FIG. 1 illustrates by way of example a soldering iron cartridge 10 (cartridge) having a sleeve 12 disposed within an insulator 14, which is also disposed within a releasable handle 16. This assembly is further adapted to electrically connect to a connector 18 having a cord extending to a plug 48.

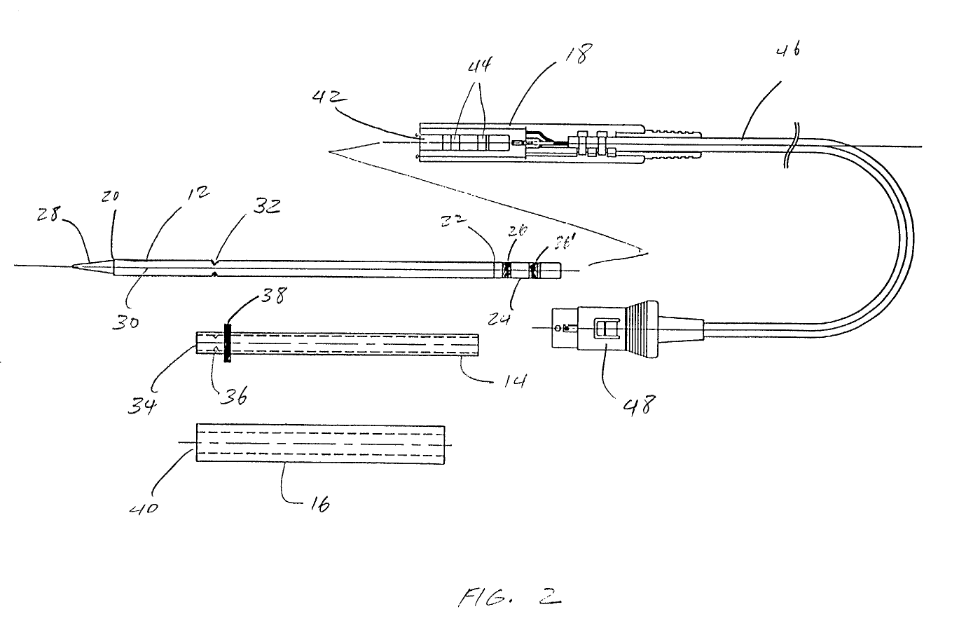

FIG. 2 illustrates by way of example the cartridge 10 disassembled. The sleeve 12 has a proximal end 22 and a distal end 20. The proximal end 22 is adapted to couple to a connector end 24 having electrical contact areas 26 and 26′. The distal end of the sleeve 12 is adapted to couple to a tip 28 which is designed to concentrate the heat generated by the electrical heating elements 30 within the sleeve 12 (not shown). That is, the electrical energy supplied to the electrical heat element 30 via the electrical contact areas 26 and 26′ are converted into heat and focused along the tip 28. Optionally, the sleeve 12 may have a notch 32 along the surface of the sleeve 12 so that it may be used to position the insulator 14 at a predetermined position relative to the sleeve 12, as further discussed below.

As illustrated by way of example in FIG. 2, the insulator 14 has an opening 34 running axially therethrough. The shape of the opening 34 may be substantially similar to the outer configuration of the sleeve 12. Once the sleeve 12 is inserted through the opening 34, the cartridge 10 may be firmly held in place. Moreover, within the opening 34 may be a tooth 36 which is adapted to engage with the notch 32 thereby positioning the insulator 14 relative to the sleeve 12 in a predetermined position. Additionally, the sleeve 12 may be fixed or releasably held within the opening 34 of the insulator 14.

Optionally, the insulator 14 may have an outer ring 38 which is made of temperature-sensitive material. That is, as the sleeve 12 near the tip 28 gets hot, the outer ring 38 may indicate such a rise in temperature by varying its color, depending on the temperature of the sleeve. This way, a user may be warned that the soldering iron is hot. Moreover, the length of the insulator 14 may be sized so that it is less than the length of the sleeve between its proximal and distal ends.

FIG. 2 also illustrates an exemplary handle 16 having a hole therethrough along the longitudinal axis. The configuration of the hole 40 may be substantially similar to the outer configuration of insulator 14. Once the insulator 14 is inserted into the hole 40, it snugly fits into the hole 40 and it is removable. The outer circumference of the handle 16 may vary in size, shape, and may be made of a variety of materials with different degrees of firmness. This allows a particular user to pick a handle that is ergonomically comfortable to grip. Because each user may have his own handle 16, the hygiene problem is minimized. Cost-wise, when the handle 16 wears out, rather than replacing the whole soldering iron cartridge 10, just the handle 16 may be replaced. The handle 16 may be made of foam and may be carbon impregnated to allow static discharge. Moreover, the handle 16, may be washable. Of course, the handle 16 may be made of a variety of materials known to those skilled in the art including rubber, elastomers, and plastics.

FIG. 2 further illustrates by example the connector 18 having a receptacle opening 42 therein. Within the receptacle opening 32 are electrical contact fingers 44 positioned to make electrical contact with the electrical contact areas 26 and 26′ of the connector end 24. That is, once the connector end 24 is inserted into the receptacle opening 42, electrical contact fingers 44 make electrical contact with the electrical contact areas 26 and 26′. Connector 18 also includes a cord 46 which is coupled to a plug 48 which is adapted to insert into an electrical outlet. Note that the length of the handle 16 is designed to fit flush against the outer ring 38 and fit flush against the opposite end. This way, once the connector end 24 is inserted into the receptacle opening 42, the connector, connector end, and the handle are flush against each other.

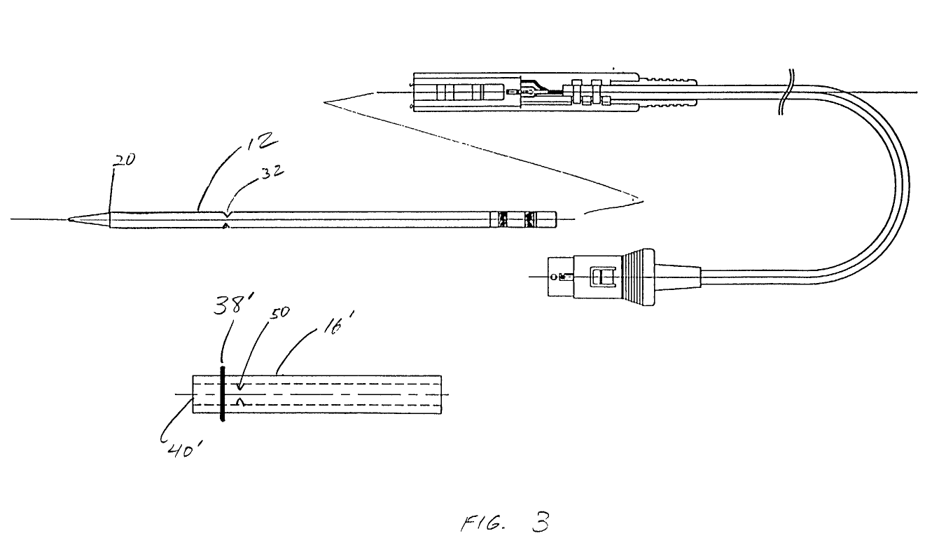

FIG. 3 illustrates by example an alternative embodiment of the present invention wherein the sleeve 12 is inserted into a hole 40′ of the handle 16′. In this embodiment, the insulator 14 is eliminated, unlike the previous embodiment in FIG. 2. The sleeve 12 may be releasable from the handle 16′, and the handle 16′ may have a tooth 50 adapted to associate with the notch 32 of the sleeve 12 to position the handle 16′ relative to the sleeve 12 at a predetermined position. One of the reasons for not needing the insulator 14 is that much of the heat is focused near the distal end 20 and minimal heat is conducted back along the sleeve 12 to the location of the notch 32, so that a handle 16′ made of foam would not degrade due to the heat. Of course, the hole 40′ is now sized to be substantially similar in dimension to the configuration of the sleeve 12. Moreover, the handle 16′ may have an outer ring 38′ to indicate the temperature of the outer ring 38′.

With regard to the cross-section of the sleeve 12, it may have a variety of cross-sectional shapes such as circular, oval, square, or rectangular. The hole 40′ however need not be similar to the cross-sectional area of the sleeve 12, although at least a portion of the hole 40′ is used to engage the outer surface of the sleeve 12 to somewhat firmly hold the sleeve 12 in its predetermined position. As such, air passageways may be formed between the handle 16′ and the sleeve 12 to radiate the heat away from the handle 16′. Of course, the cross-section of the hole 40′ may correspond to the cross-section of the sleeve 12 to make continuous contact between the handle 16′ and the surface of the sleeve 12.

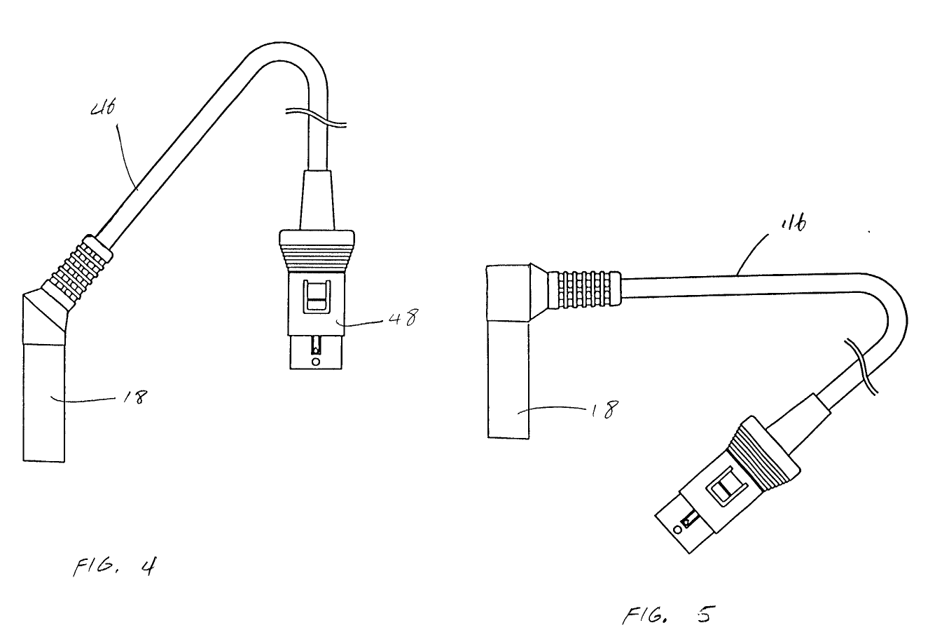

FIG. 4 illustrates by way of example an alternative way of coupling the cord 46 to the connector 18. In this embodiment, the cord 46 is coupled to the connector 18 at about a 45° angle so that it may be more comfortable for a user to hold the cartridge 10. Still further, as illustrated by way of example in FIG. 5, the core 46 may be coupled to the connector 18 at about a 90° angle to each other for application in which such relationship would aid the user in using the cartridge 10 more comfortably.

In closing, it is noted that specific illustrative embodiments of the invention have been disclosed hereinabove. With respect to the claims, it is applicant's intention that the claims not be interpreted in accordance with the sixth paragraph of 35 U.S.C. § 112 unless the term “means” is used following by a functional statement.

What is claimed is:

1. A cartridge type soldering iron assembly, comprising:
a sleeve having a proximal end and a distal end, the proximal end adapted to couple to a connector and the distal end adapted to couple to a tip; and
a handle having an opening, extending axially therethrough being dimensioned to fit over a portion of the sleeve.

2. A cartridge type soldering iron according to claim 1 further including an insulator to be positioned between the sleeve and the handle.

3. A cartridge type soldering iron according to claim 1, wherein the proximal end of the sleeve is adapted to couple to a connector end having electrical contact surface areas.

4. A cartridge type soldering iron according to claim 3, wherein the connector has a receptacle opening having contact fingers adapted to electrically couple to the electrical contact surface areas of the connector end of the cartridge.

5. A cartridge type soldering iron according to claim 3, further including an electrical heating element within the sleeve and electrically coupled to the electrical contact surface areas of the connector end to convert electrical energy into heat, thereby providing heat to the tip.

6. A cartridge type soldering iron according to claim 1 wherein the handle is made of multi-layers.

7. A cartridge type soldering iron according to claim 1, wherein the insulator has a hole, wherein within the hole of the insulator is a tooth, the sleeve having a notch at a predetermined location adapted to receive the tooth, wherein when the sleeve is inserted through the hole of the insulator and the tooth engages the notch, the sleeve is releasably locked into place relative to the insulator in the first position.

8. A cartridge type soldering iron according to claim 1, wherein the insulator has a proximal end and a distal end and the proximal end of the insulator is adjacent to the proximal end of the sleeve, the insulator having a ring at a predetermined distance from the proximal end of the insulator.

9. A cartridge type soldering iron according to claim 1, wherein the handle has a length, the length of the handle being substantially similar to the predetermined distance between the ring and the proximal end of the insulator.

10. A cartridge type soldering iron according to claim 1, wherein the handle is between the ring and the proximal end of the insulator.

11. A cartridge type soldering iron according to claim 8, wherein the ring is temperature sensitive and changes its color based on changes in temperature.

12. A cartridge type soldering iron according to claim 1, wherein the handle is made of carbon impregnated foam material for static discharging.

13. A cartridge type soldering iron according to claim 1, wherein the handle is releasable from the insulator.

14. A cartridge type soldering iron according to claim 1, wherein the cross sectional area of the sleeve is cylindrical.

15. A cartridge type soldering iron, comprising:
a sleeve having an electrical contact portion and a tip portion, the electrical contact portion adapted to releasably couple to a receptacle within a connector;
an insulator having an opening adapted to receive the sleeve, the insulator between the tip and electrical contact portions;
a ring around the insulator at a predetermined distance from the electrical contact portion; and
a handle having a hole adapted to receive the insulator, wherein the handle is between the ring and the electrical contact portion;
wherein once the electrical contact portion of the sleeve is inserted into the receptacle within the connector the insulator and the handle are flushed against the connector.

16. A cartridge type soldering iron according to claim 15, wherein the ring is temperature sensitive to indicate the temperature of the cartridge type soldering iron.

17. A cartridge type soldering iron according to claim 15, wherein the handle is releasable from the insulator.

18. A cartridge type soldering iron, comprising:
a sleeve having a proximal end and a distal end, the proximal end adapted to couple to a connector and the distal end adapted to couple to a tip; and
a handle having a hole therethrough, the sleeve releasably within the hole of the handle between the proximal and distal ends of the sleeve defining a first position.

19. A cartridge type soldering iron according to claim 18, wherein the cross-section of the hole of the handle is substantially similar to the cross-section of the sleeve, thereby the sleeve firmly fits within the hole of the handle.

20. A cartridge type soldering iron according to claim 18, wherein the cross-section of the sleeve is circular.

21. A cartridge type soldering iron according to claim 18, wherein at least a portion of the sleeve does not contact the inner wall of the hole of the handle thereby forming an air passage between the sleeve and the handle.

22. A cartridge type soldering iron according to claim 18, wherein within the hole of the handle is a tooth, the sleeve having a notch at a predetermined location adapted to receive the tooth, wherein when the sleeve is inserted through the hole of the handle and the tooth engages the notch, the sleeve is releasably locked into place relative to the handle at the first position.

23. A method for assembling a cartridge type soldering iron, comprising:
inserting a sleeve through an opening within an insulator so that the insulator is between a proximal end and a distal end of the sleeve, the proximal end of the sleeve having electrical contact surface areas;
inserting the insulator through a hole within a handle so that the handle is between the proximal and distal ends of the sleeve;
electrically connecting the proximal end of the sleeve to a connector; and
coupling a tip to the distal end of the sleeve.

24. A method according to claim 23, further comprising:
inserting the insulator through a ring at a predetermined distance from a proximal end of the insulator, wherein the proximal end of the insulator is adjacent to the proximal end of the sleeve.

25. A method according to claim 24, wherein the handle has a length, the length of the handle being substantially similar to the predetermined distance between the ring and the proximal end of the insulator.

26. A method according to claim 24, wherein the handle is between the ring and the proximal end of the insulator.

27. A method according to claim 23, wherein the receptacle has contact fingers adapted to electrically couple to the electrical contact surface areas of the sleeve.

28. A method according to claim 23, further comprising:
releasably locking the sleeve at a predetermined position on the sleeve by providing a notch on the sleeve adapted to receive a tooth within the opening of the insulator.

29. A method according to claim 24, further comprising:
changing the color of the ring to indicate an approximate temperature of the tip.

30. A method according to claim 23, further comprising:
discharging the static in the handle.

31. A method according to claim 23, further comprising replacing the handle to better fit a particular user.

32. A method according to claim 23, wherein each of the insulator and the handle has a proximal end, wherein the proximal ends of the insulator and the handle are flushed.

33. A method according to claim 32, wherein the proximal ends of the insulator and the handle are flushed against the connector once the proximal end of the sleeve is fully inserted into the receptacle of the connector.

34. A method for replacing a handle of a cartridge type soldering iron to fit a particular user, comprising:
picking a first handle that fits a first user;
inserting a sleeve through an opening within the first handle so that the first handle is releasably between the proximal and distal ends of the sleeve;
electrically connecting the proximal end of the sleeve to a connector; and
coupling a tip to the distal end of the sleeve.

35. A method according to claim 34, further comprising:
removing an existing handle on the sleeve, if any.

36. A method according to claim 34, further comprising:
removing the first handle;
picking a second handle for a second user; and
inserting the sleeve through an opening within the second handle so that the second handle is between the proximal and distal ends of the sleeve.

37. A method according to claim 34, further comprising:
providing an insulator between the sleeve and the first handle.
